(19) United States
(12) Patent Application Publication
(10) Pub. No.: US 2026/0363259 A1
(43) Pub. Date: Nov. 19, 2026

(54) STORAGE METHOD OF LIQUID MILK CONCENTRATE, LIQUID MILK CONCENTRATE AND PRODUCTION METHOD THEREOF

(71) Applicant: Meiji Co., Ltd., Tokyo (JP)

(72) Inventors: Tomokazu TATEHASHI, Kanagawa (JP); Motoki INOUE, Tokyo (JP); Masakazu NAYA, Tokyo (JP)

(73) Assignee: Meiji Co., Ltd., Tokyo (JP)

(21) Appl. No.: 19/140,566

(22) PCT Filed: Dec. 26, 2023
(86) PCT No.: PCT/JP2023/046697

§ 371 Date: Jun. 18, 2025

(30) Foreign Application Priority Data
Dec. 26, 2022 (JP) 2022-208271
Dec. 26, 2022 (JP) 2022-208272

(51) Int. Cl. A23C 1/16; A23B 11/13; A23C 9/00; A23C 9/142

(52) U.S. Cl. CPC A23C 1/16; A23B 11/13; A23C 9/005; A23C 9/1422

(57) ABSTRACT

The object of the present invention is to provide a method for preserving a liquid milk concentrate for a relatively long period of time while maintaining the viscosity of the liquid milk concentrate at a low level. In the method according to the present invention, the pH of a sterilized liquid milk concentrate is adjusted to be in the range of more than 4.6 and less than 6.5, and the liquid milk concentrate is preserved in a refrigerator. As the pH adjuster, various acids which can be added to food, such as lactic acid, acetic acid, hydrochloric acid, citric acid, and carbon dioxide, can be used. It is preferable that the dairy ingredient is skimmed milk and the milk concentrate is a milk protein concentrate.

### TECHNICAL FIELD

The present invention relates to a method of preserving liquid milk concentrates. The present invention also relates to a liquid milk concentrate and a method for producing the same.

### BACKGROUND

In the past, a “method for producing a liquid milk concentrate, comprising adding an acid to a dairy ingredient such as skimmed milk to prepare an acidic dairy ingredient, ultra-filtering the acidic dairy ingredient to prepare a milk concentrate, and finally adding sodium hydroxide, potassium hydroxide, potassium carbonate, or the like to the milk concentrate to neutralize the milk concentrate” has been proposed (see, for example, Patent Documents 1 to 5 below.).

### PRIOR ART DOCUMENTS

### Patent Documents

Patent Document 1: Japanese Laid-Open Patent Publication No. 2018-038359
Patent Document 2: Japanese Laid-Open Patent Publication No. 2018-038360
Patent Document 3: Japanese Laid-Open Patent Publication No. 2018-038361
Patent Document 4: Japanese Laid-Open Patent Publication No. 2018-064481
Patent Document 5: Japanese Laid-Open Patent Publication No. 2018-064482
Patent Document 6: Japanese Laid-Open Patent Publication No. 2018-074915

### SUMMARY OF THE INVENTION

### Problems to be Solved by the Invention

However, the liquid milk concentrate produced in this way becomes too viscous relatively quickly to be transported by tank trucks or the like. Therefore, the manufacturer of the liquid milk concentrate must transport the liquid milk concentrate immediately after the production thereof, and must be aware of the arrangement of the means of transport such as a tank car in the production thereof. Therefore, there has been a demand from manufacturers of liquid milk concentrates for a technique capable of preserving the liquid milk concentrates for a relatively long period of time while maintaining the viscosity of the liquid milk concentrates at a low level.

The object of the present invention is to provide a method for preserving a liquid milk concentrate for a relatively long period of time (about 20 to about 30 days) while maintaining the viscosity of the liquid milk concentrate at a low level. Another object of the present invention is to provide a liquid milk concentrate which can be preserved for a relatively long period of time (about 20 to 30 days) in a state where the viscosity is maintained at a low level, and a method for producing the liquid milk concentrate.

### Means for Solving the Problem

The method according to the first aspect of the present invention is a method of adjusting the pH of a sterilized liquid milk concentrate to be in the range of more than 4.6 and less than 6.5 and preserving the liquid milk concentrate in a refrigerator.

As the result of intensive studies by the inventors of the present invention, it has been found that the liquid milk concentrate can be preserved for a relatively long period of time (about 20 to about 30 days) in a state where the viscosity of the liquid milk concentrate is maintained at a low level by using the method for preserving a liquid milk concentrate according to the present invention. Note that this is true even when the protein content is high.

In the method according to the first aspect, it is preferable that the pH of the heat-sterilized liquid milk concentrate is adjusted so that the intrinsic viscosity of the heat-sterilized liquid milk concentrate at 5 °C is within a range of 0.01 dL/g or more and 0.8 dL/g or less, and the pH of the heat-sterilized liquid milk concentrate is within a range of more than 4.6 and less than 6.5. The upper limit of the intrinsic viscosity is preferably 0.5 dL/g, more preferably 0.35 dL/g, and still more preferably 0.33 dL/g. The lower limit of the intrinsic viscosity is preferably 0.1 dL/g, more preferably 0.2 dL/g, still more preferably 0.25 dL/g, and particularly preferably 0.3 dL/g. The range of the intrinsic viscosity is preferably in a range of 0.2 dL/g or more and 0.5 dL/g or less, and more preferably in the range of 0.3 dL/g or more and 0.33 dL/g or less. In addition, with regard to the relationship between the intrinsic viscosity and pH at 5 °C, it is preferable that the intrinsic viscosity is within the range of 0.1 dL/g or more and 0.5 dL/g or less, and the pH is within the range of more than 5.2 and less than 6.5, more preferably that the intrinsic viscosity is within the range of 0.2 dL/g or more and 0.35 dL/g, and the pH is within the range of more than 5.6 and less than 6.5, and still more preferably that the intrinsic viscosity is within the range of 0.3 dL/g to 0.33 dL/g, and the pH is within the range of more than 5.8 and less than 6.5.

A method for producing a liquid milk concentrate according to a second aspect of the present invention is a method for producing a liquid milk concentrate suitable in a refrigerated state, which comprises an acidification step, a concentration step, a heat sterilization step and a pH adjustment step. In the acidification step, the liquid dairy ingredient is acidified to prepare a liquid acidified dairy ingredient. It is preferable to allow the acidified dairy ingredient to stand or stir for a predetermined time before proceeding from the acidification step to the concentration step. This is because ions such as calcium are sufficiently dissociated (released) from proteins (i.e., casein, etc.). In the concentration step, the acidified dairy ingredient is ultrafiltered to prepare a liquid milk concentrate. In the heat sterilization step, the liquid milk concentrate is heated and sterilized to prepare a sterilized liquid milk concentrate. In the pH adjustment step, the pH of the sterilized liquid milk concentrate is adjusted to be in a range of more than 4.6 and less than 6.5.

As the result of intensive studies by the inventors of the present invention, it has been found that the liquid milk concentrate which can be preserved in a refrigerator for a relatively long period of time (about 30 days) in a state where the viscosity is maintained at a low level can be obtained by using the method for producing a liquid milk concentrate according to the present invention. Note that this is true even when the protein content is high.

In the above-mentioned method for producing a liquid milk concentrate, it is preferable that in the acidification step, the liquid dairy ingredient is acidified so that the pH of the liquid milk concentrate obtained in the concentration step is within a range of 6.4 or more and 7.0 or less.

As the result of the intensive studies by the present inventors, it has been found that the thermal stability of the liquid milk concentrate is good when the pH of the liquid milk concentrate is within the above range. Therefore, by using this method for producing a liquid milk concentrate, it is possible to shift from the concentration step to the heat sterilization step without going through a further pH adjustment step.

In the method for producing a liquid milk concentrate, it is preferable that the dairy ingredient is skimmed milk, and the milk concentrate is a milk protein concentrate (hereinafter abbreviated as “MPC”).

In the method for producing a liquid milk concentrate, it is preferable that in the pH adjustment step, the pH of the sterilized liquid milk concentrate is adjusted so that the intrinsic viscosity of the sterilized liquid milk concentrate at 5 °C is within a range of 0.01 dL/g or more and 0.8 dL/g or less, and the pH of the sterilized liquid milk concentrate is within a range of more than 4.6 and less than 6.5. The upper limit value, the lower limit value, and the range of the intrinsic viscosity, and the relationship between the range of the intrinsic viscosity and the range of the pH are the same as those in the description of the method according to the first aspect.

The liquid milk concentrate according to the third aspect of the present invention is produced by the method for producing a liquid milk concentrate according to the second aspect.

As the result of intensive studies by the inventors of the present invention, it has been found that the liquid milk concentrate of the present invention can be preserved in a refrigerator for a relatively long period of time (about 30 days) while maintaining a low viscosity. Note that this is true even when the protein content is high.

The milk concentrate according to the fourth aspect of the present invention is a milk concentrate which has been sterilized by heating, has an intrinsic viscosity of 0.01 dL/g or more and 0.8 dL/g or less at 5 °C, and has a pH of more than 4.6 and less than 6.5. The upper limit value, the lower limit value, and the range of the intrinsic viscosity, and the relationship between the range of the intrinsic viscosity and the range of the pH are the same as those in the description of the method according to the first aspect.

As the result of intensive studies by the inventors of the present invention, it has been found that the liquid milk concentrate of the present invention can be preserved in a refrigerator for a relatively long period of time (about 30 days) while maintaining a low viscosity. Note that this is true even when the protein content is high.

### Effect of the Invention

According to the present invention, the liquid milk concentrate can be preserved for a relatively long period of time (about 30 days) in a state where the viscosity of the liquid milk concentrate is maintained at a low level.

### DESCRIPTION OF THE PREFERRED EMBODIMENTS

The liquid milk concentrate according to the embodiment of the present invention is a liquid milk concentrate suitable for refrigerated preservation and is produced through an acidification step, a concentration step, a heat sterilization step and a pH adjustment step. The liquid milk concentrate thus produced may be subjected to neutralization treatment as required after the refrigerated preservation. The liquid milk concentrate will be described in detail, and then a method for producing the liquid milk concentrate and its use will be described in detail.

### <Liquid Milk Concentrate>

The liquid milk concentrate according to the embodiment of the present invention is a concentrate of raw milk, cow's milk, special cow's milk, skimmed milk (raw milk, cow's milk, special cow's milk from which milk fat has been removed), or partially skimmed milk (raw milk, cow's milk, special cow's milk from which milk fat has been partially removed), and is, for example, not only a concentrated milk (concentrated raw milk, cow's milk, or special cow's milk having 25.5% or more of milk solids and 7.0% or more of milk fat content) specified in the “Ministerial Ordinance Concerning Compositional Standards, etc.”, or a skimmed concentrated milk (raw milk, cow's milk, or special cow's milk from which milk fat has been removed and which is concentrated, has non-fat milk solids of 18.5% or more, and has a bacterial count (per gram by standard plate culture method) of 100,000 or less, but also “a concentrate of raw milk, cow's milk, special cow's milk having less than 25.5% of a milk solids (hereinafter referred to as “concentrated milk not specified in the Ministerial Ordinance”)”, “raw milk, cow's milk, special cow's milk from which milk fat has been removed and which is concentrated, has non-fat milk solids of less than 18.5% (hereinafter referred to as “concentrated skimmed milk not specified in the Ministerial Ordinance”)”, it is preferable to be a liquid milk protein concentrate (hereinafter abbreviated as “MPC”). For convenience of explanation, raw milk, cow's milk, special cow's milk, skimmed milk and partially skimmed milk may be collectively referred to as “dairy ingredient”.

The milk concentrate according to the embodiment of the present invention contains, per 20 mass % of the total solids, protein in the range of 7.0 mass % or more and 20.0 mass % or less, calcium (Ca) in the range of 0.20 mass % or more and 0.70 mass % or less, and magnesium (Mg) in the range of more than 0.00 mass % and 0.10 mass % or less.

The protein content of the liquid milk concentrate according to the embodiment of the present invention is preferably within the range of 7.0 mass % or more and 20.0 mass % or less, more preferably within the range of 10.0 mass % or more and 20.0 mass % or less, even more preferably within the range of 12.0 mass % or more and 20.0 mass % or less, still more preferably within the range of 14.0 mass % or more and 20.0 mass % or less, and still more preferably within the range of 16.0 mass % or more and 20.0 mass % or less, per 20 mass % of the total solids.

The content of calcium (Ca) in the milk concentrate according to the embodiment of the present invention is preferably in the range of 0.2 mass % or more and 0.7 mass % or less, more preferably in the range of 0.2 mass % or more and 0.6 mass % or less, still more preferably in the range of 0.2 mass % or more and 0.5 mass % or less, and particularly preferably in the range of 0.2 mass % or more and 0.3 mass % or less, per 20 mass % of the total solids.

The content of magnesium (Mg) in the milk concentrate according to the embodiment of the present invention is preferably in the range of more than 0.00 mass % and 0.10 mass % or less, and more preferably in the range of more than 0.00 mass % and 0.05 mass % or less, per 20 mass % of the total solids.

The total solids of the liquid milk concentrate according to the embodiment of the present invention is usually in the range of 14 mass % or more and 22 mass % or less, preferably in the range of 16 mass % or more and 22 mass % or less, more preferably in the range of 18 mass % or more and 22 mass % or less, and still more preferably in the range of 19 mass % or more and 22 mass % or less.

The viscosity of the liquid milk concentrate according to the embodiment of the present invention immediately after being preserved for 20 days in a temperature environment of 2 to 4 °C is preferably 50,000 mPas or less, more preferably 30,000 mPa's or less, still more preferably 10,000 mPas or less, still more preferably 7,000 mPa's or less, still more preferably 5,000 mPads or less, still more preferably 3,000 mPa's or less, still more preferably 2,000 mPa's or less, and particularly preferably 1,000 mPa·s or less.

The viscosity of the liquid milk concentrate according to the embodiment of the present invention immediately after being preserved for 30 days in a temperature environment of 2 to 4 °C is preferably 50,000 mPads or less, more preferably 30,000 mPa's or less, still more preferably 10,000 mPas or less, still more preferably 7,000 mPads or less, still more preferably 5,000 mPads or less, still more preferably 3,000 mPa's or less, and particularly preferably 2,000 mPa·s or less.

### <Method for Producing Liquid Milk Concentrate>

The liquid milk concentrate according to the embodiment of the present invention is produced through the acidification step, the concentration step, the heat sterilization step and the pH adjustment step as described above. When the liquid milk concentrate according to the embodiment of the present invention is a skimmed concentrated milk, a skimmed concentrated milk not specified in the Ministerial Ordinance, or a liquid milk protein concentrate, it is preferable that a skimmed milk preparation step is provided before the acidification step. As described above, the liquid milk concentrate produced in this manner may be subjected to a neutralization treatment as required upon completion of the refrigerated preservation. These steps will be described in detail below.

### (1) Skimmed Milk Preparation Step

In the skimmed milk preparation step, skimmed milk or partially skimmed milk is prepared from raw milk, cow's milk or special cow's milk. The term “skimmed milk” as used herein means raw milk, cow's milk or special cow's milk from which milk fat has been removed, such as “raw milk, cow's milk or special cow's milk with a milk fat content of less than 0.5%”. The term “partially skimmed milk” as used herein means raw milk, cow's milk or special cow's milk from which milk fat has been partially removed, and is, for example, “raw milk, cow's milk or special cow's milk with a milk fat content in the range of 0.5% or more and less than 3.0%”. As described above, the skimmed milk preparation step is not necessarily performed. It is also acceptable to purchase commercially available concentrated skimmed milk or a skimmed concentrated milk not specified in the Ministerial Ordinance and use it as a dairy ingredient (starting material) in the acidification process.

A method of preparing skimmed milk or partially skimmed milk from raw milk, cow's milk or special cow's milk include, for example, a method of centrifuging the milk fat of raw milk, cow's milk or special cow's milk (hereinafter referred to as “centrifugal separation method”), a method of membrane-separating milk fat from raw milk, cow's milk or special cow's milk (hereinafter referred to as “membrane separation method”. For example, microfiltration). When the centrifugal separation method is employed, it is preferable to centrifuge the milk fat while keeping the temperature of raw milk, cow's milk or special cow's milk within a range of 45 °C or more and 55 °C or less. In such a case, it is preferable to cool the obtained skimmed milk or partially skimmed milk before the acidification step. In this case, the cooling temperature is preferably within a range of the temperature at which the skimmed milk or partially skimmed milk remains liquid or more and 10 °C or less, and more preferably within a range of 1 °C or more and 5 °C or less.

### (2) Acidification Step

In the acidification step, an acid is added to the dairy ingredient (for example, cooled dairy ingredient) to acidify the dairy ingredient, and a liquid acidified dairy ingredient is prepared. In this case, the pH of the liquid acidified dairy ingredient is preferably determined so that the pH of the liquid milk concentrate finally obtained in the concentration step is in the range of 6.4 or more and 7.0 or less. The pH is more preferably, for example, in the range of 5.8 or more and less than 6.8, still more preferably in the range of 6.0 or more and 6.5 or less, and particularly preferably in the range of 6.1 or more and 6.3 or less. As the acid used in the acidification step, for example, an acid which is solid or liquid at room temperature and normal pressure, such as hydrochloric acid, lactic acid, acetic acid, citric acid, or the like, or an acid which is gas at room temperature and normal pressure, such as carbon dioxide, can be used. As a method of blowing carbon dioxide into the dairy ingredient, for example, a method using a normal nozzle, an in-line nozzle, a sintered metal porous filter, or the like can be employed. When the pH of the dairy ingredient is adjusted to the acidic side, calcium ions, magnesium ions, and the like electrostatically attached to proteins are dissociated from the proteins in the acidified dairy ingredient. By appropriately adjusting the pH of the dairy ingredient within the above range, the content (concentration (mass %)) of calcium ions, magnesium ions, and the like dissociated in the dairy ingredient can be adjusted.

In the acidification step, it is preferable to allow the acidified dairy ingredient to stand or stir for a predetermined time after an acid is added to the dairy ingredient. The predetermined time is preferably 0.5 hours or more, more preferably 1 hour or more, still more preferably 1.5 hours or more, and particularly preferably 2 hours or more. The predetermined time is not particularly limited, but is preferably, for example, 10 hours or less, more preferably 8 hours or less, still more preferably 6 hours or less, and particularly preferably 4 hours or less. In the acidification step, the acidified dairy ingredient is preferably left to stand or stirred at a predetermined temperature. The predetermined temperature is preferably in the range of a temperature at which the acidified dairy ingredient is kept in a liquid state or more and 15 °C or less, or less, more preferably in the range of 1 °C or more and 10 °C or less, and still more preferably in the range of 1 °C or more and 5 °C

### (3) Concentration Step

In the concentration step, after the acidification step, the acidified dairy ingredient is subjected to ultrafiltration to prepare a milk concentrate (milk protein concentrate). At this time, calcium ions, magnesium ions, and the like dissociated in the acidification step are separated from the acidified dairy ingredient (or milk concentrate) as permeate components. As the result, “a milk concentrate having a reduced content (concentration) of calcium and magnesium” is obtained. As described above, the pH of the milk concentrate obtained in this step is preferably in the range of 6.4 or more and 7.0 or less. This is because the milk concentrate having a pH within the above range has excellent thermal stability and is extremely resistant to deterioration even when heat sterilization is performed in the subsequent step. The ultrafiltration membrane used for the ultrafiltration treatment may be a flat membrane, a hollow fiber membrane, a spiral membrane, a ceramic membrane, a rotating membrane, a vibrating membrane, or the like, and the molecular weight cut-off of the ultrafiltration membrane is preferably within the range of 8,000 Da or more and 12,000 Da or less, more preferably within the range of 9,000 Da or more and 11,000 Da or less, and still more preferably within the range of 9,500 Da or more and 10,500 Da or less. The lower limit of the concentration ratio may vary depending on the type of dairy ingredient, but for example, when the dairy ingredient is skimmed milk, the concentration ratio is preferably 2.5 times or more, more preferably 3 times or more, and when the dairy ingredient is raw milk, the concentration ratio is preferably 1.5 times or more, more preferably 2 times or more. The upper limit of the concentration ratio can be determined depending on the degree of pressure resistance of the ultrafiltration membrane and the ultrafiltration device, and for example, when the dairy ingredient is skimmed milk, the concentration ratio is preferably 6 times or less, more preferably 5.5 times or less, and when the dairy ingredient is raw milk, the concentration ratio is preferably 5 times or less, more preferably 4.5 times or less.

The concentration step may be repeated. In such a case, the concentration step may be repeated continuously or intermittently with other steps interposed therebetween. The other steps in the latter case are, for example, a diafiltration step and the like. Diafiltration is a process in which a pure solvent (e.g., ion-exchanged water) is added to milk concentrates during the ultra-filtration process to continuously expel low molecules, ions, etc. The diafiltration process may also be repeated.

### (4) Heat Sterilization Step

In the heat sterilization step, the liquid milk concentrate obtained as described above is heated and sterilized to prepare a sterilized liquid milk concentrate. In the execution of the present step, the pH of the liquid milk concentrate is preferably in the range of 6.4 or more and 7.0 or less from the viewpoint of thermal stability. Examples of the method of “heat sterilization” include low-temperature holding pasteurization, continuous low-temperature pasteurization, high-temperature holding pasteurization, high-temperature short-time sterilization, and ultra-high temperature instant sterilization. Among these thermal sterilization methods, ultra-high temperature instant sterilization is most preferable. At low-temperature holding pasteurization, liquid milk concentrates are pasteurized at 63 °C to 65 °C for about 30 minutes with retention. In the continuous low-temperature pasteurization, liquid milk concentrate is heated continuously at a temperature of 65 °C to 68 °C for 30 minutes or more. In the high-temperature holding sterilization, liquid milk concentrate is heated at 75 °C or higher for 15 minutes or longer with retention. In high-temperature short-time sterilization, liquid milk concentrates are heated continuously at a temperature of 72 °C or higher for 15 seconds or longer. Also, in ultra-high temperature instant sterilization, liquid milk concentrates are heated and sterilized at a temperature of 120 to 150 °C for 2 to 3 seconds. The heat sterilization conditions at this time may be the same as the heat sterilization conditions described above with protein denaturation rate, for example, 100 °C×50 seconds.

### (5) pH Adjustment Step

In the pH adjustment step, the pH of the sterilized liquid milk concentrate is adjusted to be in the range of more than 4.6 and less than 6.5. It is because when the pH of the sterilized liquid milk concentrate is within the above range, the liquid milk concentrate is less likely to thicken when the liquid milk concentrate is preserved in a refrigerator, and the time restriction from production to transportation is relaxed. Since pH 4.6 is the isoelectric point of casein, which is the main protein species of the milk protein concentrate, the isoelectric precipitation can be prevented by setting the pH of the sterilized liquid milk concentrate to be higher than 4.6. The pH is preferably in the range of 5.0 or more and less than 6.5, more preferably in the range of 5.2 or more and less than 6.5, still more preferably in the range of 5.5 or more and less than 6.5, still more preferably in the range of 5.8 or more and less than 6.5, and particularly preferably in the range of 6.0 or more and less than 6.5. The refrigeration temperature during preservation in a refrigerator is preferably in the range of from a temperature at which the sterilized liquid milk concentrate remains liquid or more and 15 °C or less, more preferably in the range of from 1 °C or more and 10 °C or less, and still more preferably in the range of from 1 °C or more and 5 °C or less. In the pH adjustment step, an acid is used as a pH adjusting agent. As such an acid, for example, an acid which is solid or liquid at room temperature and normal pressure, such as hydrochloric acid, lactic acid, acetic acid, citric acid, or the like, or an acid which is gas at room temperature and normal pressure, such as carbon dioxide, can be used. As a method of blowing carbon dioxide into the dairy ingredient, for example, a method using a normal nozzle, an in-line nozzle, a sintered metal porous filter, or the like can be employed.

In the pH adjustment step, it is preferable to allow the sterilized liquid milk concentrate to stand or stir for a predetermined time after an acid is added to the sterilized liquid milk concentrate. The predetermined time is preferably 0.5 hours or more, more preferably 1 hour or more, still more preferably 1.5 hours or more, and particularly preferably 2 hours or more. The predetermined time is not particularly limited, but is preferably, for example, 10 hours or less, more preferably 8 hours or less, still more preferably 6 hours or less, and particularly preferably 4 hours or less. In the pH adjustment step, the sterilized liquid milk concentrate is preferably left to stand or stirred at a predetermined temperature. The predetermined temperature is preferably in the range of from a temperature at which the sterilized liquid milk concentrate remains liquid or more and 15 °C or less, more preferably in the range of 1 °C or more and 10 °C or less, and still more preferably in the range of from 1 °C or more and 5 °C or less.

In the pH adjustment step, the pH is preferably adjusted so that the intrinsic viscosity of the sterilized liquid milk concentrate at 5 °C is within the range of 0.01 dL/g or more and 0.8 dL/g or less, and the pH of the sterilized liquid milk concentrate is within the range of more than 4.6 and less than 6.5. The upper limit of the intrinsic viscosity is preferably 0.5 dL/g, more preferably 0.35 dL/g, and still more preferably 0.33 dL/g. The lower limit of the intrinsic viscosity is preferably 0.1 dL/g, more preferably 0.2 dL/g, still more preferably 0.25 dL/g, and particularly preferably 0.3 dL/g. The range of the intrinsic viscosity is preferably 0.2 dL/g or more and 0.5 dL/g or less, and more preferably 0.3 dL/g or more and 0.33 dL/g or less. In addition, with regard to the relationship between the intrinsic viscosity and pH at 5 °C, it is preferable that the intrinsic viscosity is within the range of 0.1 dL/g or more and 0.5 dL/g or less, and the pH is within the range of more than 5.2 and less than 6.5, more preferably that the intrinsic viscosity is within the range of 0.2 dL/g or more and 0.35 dL/g or less, and the pH is within the range of more than 5.6 and less than 6.5, and still more preferably that the intrinsic viscosity is within the range of 0.3 dL/g or more and 0.33 dL/g or less, and the pH is within the range of more than 5.8 and less than 6.5.

### <Neutralization Treatment>

In the neutralization treatment, the pH of the liquid milk concentrate (for example, a cooled milk concentrate or a milk concentrate at room temperature) is adjusted to be in a range of more than 6.5 and 7.0 or less to prepare a neutralized liquid milk concentrate. In the neutralization treatment, the pH of the neutralized liquid milk concentrate is preferably in the range of more than 6.5 and 6.9 or less, more preferably in the range of 6.6 or more and 6.9 or less, and still more preferably in the range of 6.7 or more and 6.9 or less. In the neutralization treatment, at least one of a) an alkali addition treatment in which an alkali is added to the liquid milk concentrate and b) a desorption treatment in which carbon dioxide is desorbed from the liquid milk concentrate is performed. When both the desorption treatment and the alkali addition treatment are performed, it is desirable that the alkali addition treatment is performed after the desorption treatment. The desorption treatment and the alkali addition treatment will be described in detail below.

### (1) Alkali Addition Treatment

In the alkali addition treatment, an alkali which can be added to food, that is, an alkali harmless to the human body, such as sodium hydroxide, potassium hydroxide, potassium carbonate, or the like, is used. In this case, the alkali is preferably used in the form of a dilute aqueous solution, more preferably in the form of an aqueous alkali solution of 0.5 to 3 N, and still more preferably in the form of an aqueous alkali solution of 2 N. In this case, it is preferable to use a mixed aqueous solution of sodium hydroxide and potassium hydroxide so that the ratio of sodium ions/potassium ions in the dairy ingredient is equal to or close to the ratio of sodium ions/potassium ions in the liquid milk concentrate, specifically, it is more preferable to use a mixed aqueous solution of sodium hydroxide: potassium hydroxide in a ratio of 2 to 4:8 to 6, and it is even more preferable to use a mixed aqueous solution of sodium hydroxide: potassium hydroxide in a ratio of 3 to 7.

In the alkali addition treatment, it is preferable that the neutralized liquid milk concentrate is left to stand or stirred for a predetermined time after the alkali is added to the liquid milk concentrate. The predetermined time is preferably 0.1 hours or more, more preferably 0.3 hours or more, still more preferably 0.5 hours or more, and particularly preferably 1 hour or more. The upper limit of the predetermined time is not particularly limited, but the predetermined time is preferably, for example, 10 hours or less, more preferably 8 hours or less, still more preferably 6 hours or less, and particularly preferably 4 hours or less. In the neutralization treatment, it is preferable to leave the neutralized liquid milk concentrate or to stir the neutralized liquid milk concentrate at a predetermined temperature. The predetermined temperature is preferably in the range of from a temperature at which the neutralized liquid milk concentrate remains liqui or more and 25 °C or less, more preferably in the range of from 1 °C or more and 20 °C or less, still more preferably in the range of from 2 °C or more and 15 °C or less, and particularly preferably in the range of from 3 °C or more and 10 °C or less.

### (2) Desorption Treatment

In the desorption treatment, at least one of i) a blowing treatment in which an inert gas is blown into the liquid milk concentrate, ii) a depressurization treatment in which the liquid milk concentrate is placed under a depressurized environment, and iii) a holding treatment in which the milk concentrate is held by applying heat or physical stimulation while stirring the milk concentrate in a tank, is performed. When both the blowing treatment and the reduced pressure treatment are performed, it is desirable that these treatments are performed simultaneously. The blowing treatment and the holding treatment, the pressure reducing treatment and the holding treatment may be performed simultaneously. Examples of the inert gas used in the blowing treatment include nitrogen gas, helium gas, and argon gas. The blowing method may be, for example, a method using a normal nozzle or an in-line nozzle.

### <Use of Milk Concentrate>

The milk concentrate according to the embodiment of the present invention, particularly the milk concentrate after neutralization treatment, can be used as one component of a raw material for a dairy product. That is, the milk concentrate may be used as a raw material (dairy ingredient) of a dairy product alone, or may be used as a raw material (a part of dairy ingredient) of a dairy product by mixing with other raw materials such as water, raw milk, sterilized milk, skimmed milk, whole milk powder, skimmed milk powder, whole concentrated milk, concentrated skimmed milk, butter milk, butter, cream, cheese, and the like.

The above-mentioned dairy products include, for example, milk beverages (including processed milk), yogurts, lactic acid bacteria beverages, fermented milk, ice creams, creams, cheeses, and the like. Any optional ingredients may be added to the dairy product as needed. Such optional ingredients include, but are not limited to, sweeteners, acidulants, vegetables, fruits, and seeds, vegetable juices, fruit juices, and seed juices, extracts of vegetables, fruits, and seeds, nutritional materials such as vitamins, minerals, peptides, and amino acids, useful microorganisms such as lactic acid bacteria, bifidobacteria, and propionic acid bacteria, cultures of useful microorganisms, fermented products of useful microorganisms, existing functional materials such as royal jelly, glucosamine, astaxanthin, and polyphenols, flavoring agents, pH adjusters, excipients, acidulants, coloring agents, emulsifying agents, and preservatives, which are ingredients that are blended in general dairy products. Examples of the sweeteners include glucose, fructose, maltose, sucrose, oligosaccharides, sugars, honeys, maple syrups, agave syrups, baumsugars, molasses, starch syrup, glucose fructose liquid sugar, trehalose, maltose, palatinose, xylitol, sorbitol, licorice extract, stevia processed sweeteners, Momordica grosvenorii extract, thaumatin, glycerin, curculin, monellin, miraculin, erythritol, and the like. These sweeteners can not only impart sweetness to dairy products but also suppress sourness and “bitterness”, and therefore, it is preferable to actively add them to dairy products during the production of the dairy products.

When the above-mentioned dairy product is fermented milk, the milk concentrate may be used as one component of a raw material mix of the fermented milk. In the preparation of the raw material mix of fermented milk, raw materials such as milk concentrate and other optional components (e.g., sweetener, acidulant, mineral, vitamin, flavoring agent, etc.) are added (blended), heated, mixed, and dissolved. The raw material mix may contain, in addition to the milk concentrate, water, raw milk, pasteurized milk, whole milk powder, whole concentrated milk, butter milk, butter, cream, cheese, etc., and may be heated, mixed, dissolved, etc. Further, whey protein concentrate (WPC), whey protein isolate (WPI), α-lactalbumin (α-La), β-lactoglobulin (β-Lg), or the like may be added, heated, mixed, and dissolved in the raw material mix.

When the above-mentioned dairy product is fermented milk, the fermented milk is produced through steps such as a step of preparing the raw material mix, a step of sterilizing the raw material mix (by heating), a step of cooling the raw material mix, a step of adding a starter, a step of fermentation, and a step of cooling the fermented milk, as in the case of the conventional method of producing fermented milk. In this case, in the step of preparing the raw material mix, the raw materials are added, heated, mixed, dissolved (mixed), and the like, as described above. In each of the above-mentioned steps, the processing conditions for producing ordinary fermented milk may be appropriately adopted. The steps of sterilizing the raw material mix (by heating), cooling the raw material mix, adding the starter, fermenting, and cooling the fermented milk are preferably performed in this order.

### Characteristics of Liquid Milk Concentrate according to Embodiment of the Invention

The liquid milk concentrate obtained as described above is inhibited in an increase in viscosity over a relatively long period of time as compared with the conventional liquid milk concentrate.

### Working Example

The present invention will be described in more detail below with reference to WORKING EXAMPLES and COMPARATIVE EXAMPLES. The present invention is not limited to this embodiment.

### Working Example 1

By blowing carbon dioxide into 985 kg of skimmed milk (solids concentration: 9.4 mass %, protein content: 3.4 mass %, calcium concentration: 119 mg %) using a microbubble nozzle manufactured by Sakamoto Giken Co., Ltd., the pH of skimmed milk was lowered from 6.78 to 6.15 to prepare acidified skimmed milk. The acidified skimmed milk was concentrated using an ultrafiltration membrane (molecular weight cut-off: 10,000 Da, membrane area: 6.1 m²) manufactured by KOCH Company. Along the way, ion-exchanged water was added to the acidified skimmed milk being concentrated to perform diafiltration, and the acidified skimmed milk was further concentrated. As the result, 135 kg of liquid milk protein concentrate (MPC) with 20.9 mass % of total solids, 16.9 mass % of protein content, 408 mg % of calcium concentration, and pH 6.53 was obtained. A portion of the milk protein concentrate was then taken out, divided into two portions, and one of the portions was diluted with water to give the milk protein concentrate having 19.9 mass % of total solids, 16.1 mass % of protein content, and pH 6.60. The other portion was diluted with a different amount of water to give the milk protein concentrate having 18.2 mass % of total solids, 14.7 mass % of protein content, and pH 6.61. Hereinafter, the milk protein concentrate containing 20.9 mass % of total solids is referred to as a 1^{st} milk protein concentrate, the milk protein concentrate containing 19.9 mass % of total solids is referred to as a 2^{nd} milk protein concentrate, and the milk protein concentrate containing 18.2 mass % of total solids is referred to as a 3^{rd} milk protein concentrate. The 1^{st} milk protein concentrate, the 2^{nd} milk protein concentrate and the 3^{rd} milk protein concentrate were confirmed to have 12 minutes or more in a thermal coagulation time at 130 °C, and all of them had sufficient thermal stability.

Subsequently, the 1^{st} milk protein concentrate, the 2^{nd} milk protein concentrate, and the 3^{rd} milk protein concentrate were each subjected to a heat sterilization treatment at 130 °C for 4 seconds, thereby obtaining a sterilized 1^{st} milk protein concentrate, a sterilized 2^{nd} milk protein concentrate, and a sterilized 3^{rd} milk protein concentrate. The sterilized 1^{st} milk protein concentrate had 20.4 mass % of total solids, 16.6 mass % of protein content, and pH 6.68. The sterilized 2^{nd} milk protein concentrate had 19.4 mass % of total solids, 15.9 mass % of protein content, and pH 6.69. The sterilized 3^{rd} milk protein concentrate had 18.2 mass % of total solids, 14.9 mass % of protein content, and pH 6.70.

Subsequently, the sterilized 1^{st} milk protein concentrate was divided into two portions, one of the portions was blown with carbon dioxide until the pH of the portion reached 6.37, and the other portion was left as it was. Hereinafter, the former sterilized 1^{st} milk protein concentrate is referred to as an 11^{th} milk protein concentrate (pH6.37), and the latter sterilized 1^{st} milk protein concentrate is referred to as a 12^{th} milk protein concentrate (pH6.68). The 11^{th} milk protein concentrate corresponds to one for the WORKING EXAMPLE, and the 12^{th} milk protein concentrate corresponds to one for the COMPARATIVE EXAMPLE. The sterilized 2^{nd} milk protein concentrate was also divided into two portions, one of the portions was blown with carbon dioxide until the pH of the portion reached 6.35, and the other portion was left as it was. Hereinafter, the former sterilized 2^{nd} milk protein concentrate is referred to as a 21^{st} milk protein concentrate (pH6.35), and the latter sterilized 2^{nd} milk protein concentrate is referred to as a 22^{nd} milk protein concentrate (pH6.69). The 21^{st} milk protein concentrate corresponds to one for the WORKING EXAMPLE, and the 22^{nd} milk protein concentrate corresponds to one for the COMPARATIVE EXAMPLE. The sterilized 3^{rd} milk protein concentrate was also divided into three portions, one of the portions was blown with carbon dioxide until the pH of the portion reached 6.16, the other portion was blown with carbon dioxide until the pH of the portion reached 6.49, and the other was left as it was. Hereinafter, the first pasteurized 3^{rd} milk protein concentrate is referred to as the 31^{st} milk protein concentrate (pH6.16), the next pasteurized 3^{rd} milk protein concentrate is referred to as the 32^{nd} milk protein concentrate (pH6.49), and the last pasteurized 3^{rd} milk protein concentrate is referred to as the 33^{rd} milk protein concentrate (pH6.70). In this case, the 31^{st} milk protein concentrate corresponds to one for the WORKING EXAMPLE, the 32^{nd} milk protein concentrate corresponds to one for the WORKING EXAMPLE, and the 33^{rd} milk protein concentrate corresponds to one for the COMPARATIVE EXAMPLE. Table 1 below summarizes the physical properties of the milk protein concentrates described above.

The quantitative analysis of the above-mentioned components was performed as follows.
Protein content: Improved DUMA method (combustion method)
Calcium concentration: ICP emission spectrometry (high-frequency inductively coupled plasma emission spectrometry)

TABLE 1

| | | Total Solids | Protein Content |
|---|---|---|---|
| | pH | (mass %) | (mass %) |
| 11th Milk Protein Concentrate | 6.37 | 20.4 | 16.6 |
| 12th Milk Protein Concentrate | 6.68 | 20.4 | 16.6 |
| 21st Milk Protein Concentrate | 6.35 | 19.4 | 15.9 |
| 22nd Milk Protein Concentrate | 6.69 | 19.4 | 15.9 |
| 31st Milk Protein Concentrate | 6.16 | 18.2 | 14.9 |
| 32nd Milk Protein Concentrate | 6.49 | 18.2 | 14.9 |
| 33rd Milk Protein Concentrate | 6.70 | 18.2 | 14.9 |

The above-mentioned seven kinds of milk protein concentrates (see Table 1) were preserved at 2 to 4 °C, and the transition of the viscosity of the milk protein concentrates was measured by a B-type viscometer TVB-10M manufactured by Toki Sangyo Co., Ltd., and the results shown in Tables 2 to 8 were obtained. In order to prevent the milk protein concentrate from spoiling during refrigerated preservation, 2-bromo-2-nitropropane-1,3-diol was added to each milk protein concentrate before refrigerated preservation so that the final concentration of 2-bromo-2-nitropropane-1, 3-diol was 0.02 mass %. Where the result for the 11^{th} milk protein concentrate is shown in Table 2, the result for the 12^{th} milk protein concentrate is shown in Table 3, the result for the 21^{st} milk protein concentrate is shown in Table 4, the result for the 22^{nd} milk protein concentrate is shown in Table 5, the result for the 31^{st} milk protein concentrate is shown in Table 6, the result for the 32^{nd} milk protein concentrate is shown in Table 7, and the result for the 33^{rd} milk protein concentrate is shown in Table 8. The tables also show the measurement conditions for viscosity measurement. The results showed that the viscosity of the one prepared at a pH of less than 6.5 was kept lower than that of the one prepared at a pH of 6.5 or more during refrigerated preservation.

TABLE 2

| | | Measure- | | | |
|---|---|---|---|---|---|
| Preserved | Viscos- | ment | | Rotational | Measure- |
| Period | ity | Temperature | Spindle | Speed | ment Time |
| (day(s)) | (mPa · s) | (°C) | # | (rpm) | (Second(s)) |
| 1 | 1046 | 4.9 | M2 | 12 | 60 |
| 5 | 5260 | 5.3 | M3 | 12 | 60 |
| 7 | 7390 | 4.3 | M3 | 12 | 60 |
| 11 | 16070 | 4.3 | M4 | 12 | 60 |
| 14 | 19790 | 4.3 | M4 | 12 | 60 |
| 20 | 30510 | 4.7 | M4 | 12 | 60 |
| 28 | 37520 | 4.7 | M4 | 12 | 60 |

TABLE 3

| | | Measure- | | | |
|---|---|---|---|---|---|
| Preserved | Viscos- | ment | | Rotational | Measure- |
| Period | ity | Temperature | Spindle | Speed | ment Time |
| (day(s)) | (mPa · s) | (°C) | # | (rpm) | (Second(s)) |
| 1 | 6940 | 9.0 | M3 | 12 | 60 |
| 5 | 43400 | 5.3 | M4 | 12 | 60 |
| 7 | 48360 | 5.0 | M4 | 12 | 60 |
| 11 | 357200 | 4.6 | M4 | 1.5 | 60 |
| 14 | 891000 | 4.3 | M4 | 0.6 | 60 |
| 20 | 1000000 | 4.7 | M4 | 0.6 | 60 |
| | or more | | | | |
| 28 | 1000000 | 4.8 | M4 | 0.6 | 60 |
| | or more | | | | |

TABLE 4

| | | Measure- | | | |
|---|---|---|---|---|---|
| Preserved | Viscos- | ment | | Rotational | Measure- |
| Period | ity | Temperature | Spindle | Speed | ment Time |
| (day(s)) | (mPa · s) | (°C) | # | (rpm) | (Second(s)) |
| 1 | 356 | 5.0 | M2 | 12 | 60 |
| 5 | 989 | 4.8 | M2 | 12 | 60 |
| 7 | 1435 | 4.1 | M2 | 12 | 60 |
| 11 | 3480 | 4.2 | M3 | 12 | 60 |
| 14 | 5170 | 4.4 | M3 | 12 | 60 |
| 20 | 6460 | 4.6 | M3 | 12 | 60 |
| 28 | 11700 | 4.6 | M3 | 12 | 60 |

TABLE 5

| | | Measure- | | | |
|---|---|---|---|---|---|
| Preserved | Viscos- | ment | | Rotational | Measure- |
| Period | ity | Temperature | Spindle | Speed | ment Time |
| (day(s)) | (mPa · s) | (°C) | # | (rpm) | (Second(s)) |
| 1 | 2347 | 8.7 | M2 | 12 | 60 |
| 5 | 22280 | 4.9 | M4 | 12 | 60 |
| 7 | 25830 | 4.5 | M4 | 12 | 60 |
| 11 | 37140 | 4.7 | M4 | 12 | 60 |
| 14 | 39510 | 4.4 | M4 | 12 | 60 |
| 20 | 86000 | 5.4 | M4 | 6 | 60 |
| 28 | 91600 | 4.9 | M4 | 6 | 60 |

TABLE 6

| | | Measure- | | | |
|---|---|---|---|---|---|
| Preserved | Viscos- | ment | | Rotational | Measure- |
| Period | ity | Temperature | Spindle | Speed | ment Time |
| (day(s)) | (mPa · s) | (°C) | # | (rpm) | (Second(s)) |
| 1 | 123 | 5.0 | M1 | 12 | 60 |
| 5 | 267 | 4.5 | M2 | 12 | 60 |
| 7 | 364 | 4.2 | M2 | 12 | 60 |
| 11 | 575 | 3.7 | M2 | 12 | 60 |
| 14 | 705 | 3.6 | M2 | 12 | 60 |
| 20 | 898 | 4.4 | M2 | 12 | 60 |
| 27 | 1319 | 4.1 | M2 | 12 | 60 |

TABLE 7

| | | Measure- | | | |
|---|---|---|---|---|---|
| Preserved | Viscos- | ment | | Rotational | Measure- |
| Period | ity | Temperature | Spindle | Speed | ment Time |
| (day(s)) | (mPa · s) | (°C) | # | (rpm) | (Second(s)) |
| 1 | 253 | 4.9 | M1 | 12 | 60 |
| 5 | 658 | 4.6 | M2 | 12 | 60 |
| 7 | 777 | 4.4 | M2 | 12 | 60 |
| 11 | 1418 | 3.9 | M2 | 12 | 60 |
| 14 | 1808 | 3.9 | M2 | 12 | 60 |
| 20 | 3000 | 4.3 | M3 | 12 | 60 |
| 27 | 5490 | 4.2 | M3 | 12 | 60 |

TABLE 8

| | | Measure- | | | |
|---|---|---|---|---|---|
| Preserved | Viscos- | ment | | Rotational | Measure- |
| Period | ity | Temperature | Spindle | Speed | ment Time |
| (day(s)) | (mPa · s) | (°C) | # | (rpm) | (Second(s)) |
| 1 | 787 | 8.0 | M2 | — | — |
| 5 | 3820 | 5.1 | M3 | 12 | 60 |
| 7 | 5290 | 4.7 | M3 | 12 | 60 |
| 11 | 9930 | 3.9 | M3 | 12 | 60 |
| 14 | 21360 | 4.5 | M4 | 12 | 60 |
| 20 | 36580 | 3.8 | M4 | 12 | 60 |
| 27 | 42850 | 4.8 | M4 | 12 | 60 |

### Working Example 2

A 916 kg of skimmed milk (solids concentration 9.2 mass %, protein content 3.3 mass %, calcium concentration 122 mg %, pH 6.82) was concentrated without acidification using the same ultrafiltration membrane as shown in the WORKING EXAMPLE 1. Along the way, ion-exchanged water was added to the skimmed milk being concentrated to perform diafiltration, and the skimmed milk was further concentrated. As the result, 132 kg of liquid milk protein concentrate (MPC) with 19.7 mass % of total solids, 15.9 mass % of protein content, 431 mg % of calcium concentration, and pH 6.95 was obtained. The thermal coagulation time of the milk protein concentrate at 130 °C was 12 minutes, and the milk protein concentrate retained sufficient thermal stability. Next, the milk protein concentrate was subjected to heat sterilization at 130 °C for 4 seconds to obtain a sterilized 4^{th} milk protein concentrate. The sterilized 4^{th} milk protein concentrate was divided into two portions, one of the portions was blown with carbon dioxide until the pH of the portion reached 6.26, thereby obtaining a sterilized 41^{st} milk protein concentrate. The other portion was left as it was and was designated as sterilized 42^{nd} milk protein concentrate (sterilized 42^{nd} milk protein concentrate is treated as the one for COMPARATIVE EXAMPLE).

As in the WORKING EXAMPLE 1, the sterilized 41^{st} milk protein concentrate and the sterilized 42^{nd} milk protein concentrate were preserved at 2 to 4 °C, and the transition of the viscosity of the milk protein concentrate was measured by a B-type viscometer TVB-10M manufactured by Toki Sangyo Co., Ltd., and the results shown in Tables 9 and 10 were obtained. In order to prevent the milk protein concentrate from spoiling during refrigerated preservation, 2-bromo-2-nitropropane-1,3-diol was added to each milk protein concentrate before refrigerated preservation so that the final concentration of 2-bromo-2-nitropropane-1,3-diol was 0.02 mass %. Where the result for the 41^{st} milk protein concentrate is shown in Table 9, and the result for the 42^{nd} milk protein concentrate is shown in Table 10. The tables also show the measurement conditions for viscosity measurement. The results showed that even when skimmed milk was not acidified, the viscosity of the one that the pH was adjusted after sterilization was maintained lower during refrigerated preservation than the one that the pH was not adjusted after sterilization.

TABLE 9

| | Viscosity Measurement | | | | | | CO₂ Conc. |
|---|---|---|---|---|---|---|---|
| | | Measurement | | Rotational | Measurement | pH | Measurement |
| Preserved Period | Viscosity | Temperature | | Speed | Time | Measurement | CO₂ Conc. |
| (day(s)) | (mPa · s) | (°C) | Spindle # | (rpm) | (Second(s)) | pH | (mg/L) |
| 0 | 93 | 5.6 | M1 | 12 | 60 | 6.26 | — |
| 3 | 3450 | 4.7 | M3 | 12 | 60 | 6.35 | 83 |
| 7 | 9120 | 5.0 | M3 | 12 | 60 | 6.48 | 51 |
| 12 | 14570 | 4.8 | M4 | 12 | 60 | 6.47 | 47 |
| 21 | 21100 | 4.9 | M4 | 12 | 60 | 6.51 | 43 |

TABLE 10

| | Viscosity Measurement | | | | | | CO₂ Conc. |
|---|---|---|---|---|---|---|---|
| | | Measurement | | Rotational | Measurement | pH | Measurement |
| Preserved Period | Viscosity | Temperature | | Speed | Time | Measurement | CO₂ Conc. |
| (day(a)) | (mPa · s) | (°C) | Spindle # | (rpm) | (Second(s)) | pH | (mg/L) |
| 0 | 2940 | 9.7 | M3 | 12 | 60 | 6.96 | — |
| 3 | 1000000 | 6.0 | M4 | 0.6 | 60 | 6.96 | 1 |
| 7 | 1000000 | 5.3 | M4 | 0.6 | 60 | 7.02 | — |
| 14 | 1000000 | 5.0 | M4 | 0.6 | 60 | 6.98 | — |
| 21 | 1000000 | 5.1 | M4 | 0.6 | 60 | 7.04 | — |

### Working Example 3

By blowing carbon dioxide into 840 kg of skimmed milk (solids concentration 9.2 mass %, protein content 3.5 mass %, calcium concentration 123 mg %) using a microbubble nozzle manufactured by Sakamoto Giken Co., Ltd., the pH of skimmed milk was lowered from 6.75 to 6.16 to prepare acidified skimmed milk. The acidified skimmed milk was concentrated using an ultrafiltration membrane (molecular weight cut-off: 10,000 Da, membrane area: 6.1 m²) manufactured by KOCH Company. Along the way, ion-exchanged water was added to the acidified skimmed milk being concentrated to perform diafiltration, and the acidified skimmed milk was further concentrated. As the result, 116 kg of liquid milk protein concentrate (MPC) with 21.0 mass % of total solids, 17.0 mass % of protein content, 395 mg % of calcium concentration, and pH 6.49 was obtained. The milk protein concentrate was then diluted with water to give a total solids content of 19.2 mass %, a protein content of 15.5 mass %, and pH 6.53. The thermal coagulation time of the milk protein concentrate at 130 °C was 12 minutes, and the milk protein concentrate retained sufficient thermal stability. Subsequently, the milk protein concentrate was subjected to heat sterilization at 130 °C for 4 seconds to obtain a sterilized 5^{th} milk protein concentrate. The sterilized 5^{th} milk protein concentrate was divided into two portions, 0.5N hydrochloric acid was added to one of the portions until the pH of the portion was 5.20 to obtain a sterilized 51^{st} milk protein concentrate. The other portion was added with water so that the solids concentration was the same as that of the sterilized 51^{st} milk protein to obtain a sterilized 52^{nd} milk protein concentrate (the sterilized 52^{nd} milk protein concentrate was treated as the one for the COMPARATIVE EXAMPLE).

As in the WORKING EXAMPLE 1, the sterilized 51^{st} milk protein concentrate and the sterilized 52^{nd} milk protein concentrate were preserved at 2 to 4 °C, and the transition of the viscosity of the milk protein concentrate was measured by a B-type viscometer TVB-10M manufactured by Toki Sangyo Co., Ltd., and the results shown in Tables 11 and 12 were obtained. In order to prevent the milk protein concentrate from spoiling during refrigerated preservation, 2-bromo-2-nitropropane-1,3-diol was added to each milk protein concentrate before refrigerated preservation so that the final concentration of 2-bromo-2-nitropropane-1,3-diol was 0.02 mass %. Where the result for 51^{st} milk protein concentrate is shown in Table 11 and the result for 52^{nd} milk protein concentrate is shown in Table 12. The tables also show the measurement conditions for viscosity measurement. The results showed that regardless of the type of acid, the viscosity of the one that the pH was adjusted after sterilization was maintained lower during refrigerated preservation than the one that the pH was not adjusted after sterilization.

TABLE 11

| | Viscosity Measurement | | | | | | CO₂ Conc. |
|---|---|---|---|---|---|---|---|
| | | Measurement | | Rotational | Measurement | pH | Measurement |
| Preserved Period | Viscosity | Temperature | | Speed | Time | Measurement | CO₂ Conc. |
| (day(s)) | (mPa · s) | (°C) | Spindle # | (rpm) | (Second(s)) | pH | (mg/L) |
| 2 | 830 | 6.5 | M2 | 12 | 60 | 5.23 | 1 |
| 6 | 930 | 4.9 | M2 | 12 | 60 | 5.27 | 1 |
| 13 | 920 | 5.0 | M2 | 12 | 60 | — | — |
| 20 | 940 | 4.7 | M2 | 12 | 60 | 5.25 | 2 |
| 27 | 840 | 4.9 | M2 | 12 | 60 | — | — |
| 34 | 880 | 5.3 | M2 | 12 | 60 | — | — |
| 41 | 850 | 5.5 | M2 | 12 | 60 | 5.20 | 4 |

TABLE 12

| | Viscosity Measurement | | | | | | CO₂ Conc. |
|---|---|---|---|---|---|---|---|
| | | Measurement | | Rotational | Measurement | pH | Measurement |
| Preserved Period | Viscosity | Temperature | | Speed | Time | Measurement | CO₂ Conc. |
| (day(s)) | (mPa · s) | (°C) | Spindle # | (rpm) | (Second(s)) | pH | (mg/L) |
| 2 | 1910 | 5.6 | M2 | — | — | 6.56 | 2 |
| 6 | 29200 | 4.7 | M4 | 12 | 60 | 6.55 | 1 |
| 13 | 39100 | 5.0 | M4 | 12 | 60 | — | — |
| 20 | 46700 | 4.8 | M4 | 12 | 60 | 6.60 | 1 |
| 27 | 50100 | 4.9 | M4 | 12 | 60 | — | — |
| 34 | 53300 | 5.2 | M4 | 12 | 60 | — | — |
| 41 | 55400 | 5.6 | M4 | 12 | 60 | 6.59 | 4 |

### Working Example 4

An acidified milk protein concentrate was prepared by blowing carbon dioxide through a sintered metal porous filter into 1,020 kg of a milk protein concentrate (solids concentration 21.2 mass %, protein content 11.9 mass %, calcium concentration 384 mg %) obtained by concentrating skimmed milk using an ultrafiltration membrane (molecular weight cut-off: 10,000 Da, membrane area: 20.0 m²) manufactured by KOCH Co., Ltd., to lower the pH of the milk protein concentrate from 6.7 to 6.5. Next, the acidified milk protein concentrate was diafiltered by adding ion exchanged water thereto using an ultrafiltration membrane (molecular weight cut-off: 10,000 Da, membrane area: 6.1 m²) manufactured by KOCH Company, and then the acidified milk protein concentrate was further concentrated. As the result, 642 kg of liquid milk protein concentrate (MPC) with 19.8 mass % of total solids, 15.7 mass % of protein content, 456 mg % of calcium concentration, and pH 6.6 was obtained. The milk protein concentrate was then diluted with water to give a total solids of 19.5 mass %, a protein content of 15.6 mass %, and pH 6.6. The thermal coagulation time of the milk protein concentrate at 130 °C was 11 min, and the milk protein concentrate retained sufficient thermal stability. Subsequently, the milk protein concentrate was subjected to heat sterilization treatment at 100 °C for 50 seconds to obtain a sterilized 6^{th} milk protein concentrate. The sterilized 6^{th} milk protein concentrate was divided into five portions, one of the portions was designated as sterilized 61^{st} milk protein concentrate (the sterilized 61^{st} milk protein concentrate is treated as the one for the COMPARATIVE EXAMPLE). Hydrochloric acid (HCl) was added to the second one until the pH thereof reached 6.4 to obtain sterilized 62^{nd} milk protein concentrate (the 62^{nd} sterilized milk protein concentrate is treated as the one for the WORKING EXAMPLE). Hydrochloric acid (HCl) was added to the third one until the pH thereof reached 5.9 to obtain sterilized 63^{rd} milk protein concentrate (the sterilized 63^{rd} milk protein concentrate is treated as the one for the WORKING EXAMPLE). Hydrochloric acid (HCl) was added to the fourth one until the pH thereof reached 5.6 to obtain sterilized 64^{th} milk protein concentrate (the sterilized 64^{th} milk protein concentrate is treated as the one for the WORKING EXAMPLE). Hydrochloric acid (HCl) was also added to the last one until the pH thereof reached 5.2 to obtain a sterilized 65^{th} milk protein concentrate (the sterilized 65^{th} milk protein concentrate is treated as the one for the WORKING EXAMPLE).

The intrinsic viscosities (dL/g) of the five pasteurized milk protein concentrates were then determined, and the results shown below were obtained. The intrinsic viscosity is a characteristic value indicating the extent of molecular chains of a polymer (protein in this case) in a solution, and in this case, all solids contained in a protein concentrate were measured, and the measured value was set to correspond to the intrinsic viscosity as a whole.
Sterilized 61^{st} milk protein concentrate: 0.349 dL/g
Sterilized 62^{nd} milk protein concentrate: 0.330 dL/g
Sterilized 63^{rd} milk protein concentrate: 0.314 dL/g
Sterilized 64^{th} milk protein concentrate: 0.291 dL/g
Sterilized 65^{th} milk protein concentrate: 0.772 dL/g

The factors that increase the intrinsic viscosity of the milk protein concentrate include, for example, heat sterilization and an increase in calcium ions in the milk protein concentrate. When heat sterilization is performed, a part of the denatured whey protein is bound to the surface of the micelle, and another part of the denatured whey protein forms a complex with K-casein. The micelle size increases and the intrinsic viscosity increases due to the binding of denatured whey protein to the micelle.

On the other hand, as factors for lowering the intrinsic viscosity of the milk protein concentrate, for example, sterilization treatment such as pulse electrolytic sterilization treatment in which the whey protein is less denatured, and an increase in sucrose can be cited.

Regarding the relationship with pH, since the intrinsic viscosity of the 64^{th} sterilized milk protein concentrate was at the minimum, it was considered that the intrinsic viscosity decreases as the pH of milk protein concentrate approaches 5.6, and increases as the pH of milk protein concentrate goes away from 5.6.

The intrinsic viscosity of the milk protein concentrate was determined by the following method.

First, each milk protein concentrate was diluted with ion-exchanged water to a solids concentration of 0.2, 0.4, 0.6, 0.8, or 1.0 mass %. For convenience of explanation, the milk protein concentrate diluted with ion-exchanged water is hereinafter referred to as “milk protein concentrate diluent”.

The viscosity of the milk protein concentrate diluent was then measured using a modular compact rheometer MCR302 manufactured by Anton Paar GmbH equipped with a coaxial double cylinder system under the conditions of a measurement temperature of 5 °C and a shear rate of 2 to 200 s⁻¹. The zero shear viscosity of the milk protein concentrate diluent was determined from the measurement data in the Newtonian region within the measurement range, and was used as the viscosity of the milk protein concentrate diluent of each concentration. In addition, when determining the zero shear viscosity, the density of the milk protein concentrate diluent was set to 1. Similarly, the zero shear viscosity of the ion-exchanged water was determined and used as the viscosity of the solvent.

Next, the viscosities of the milk protein concentrate diluent and the ion-exchanged water obtained as described above were substituted into the following formula (1) to obtain the specific viscosity of each milk protein concentrate diluent.

ηₛₚ=(η−ηₛ)/ηₛ (1)

In the above equation (1), ηₛₚ is the specific viscosity of the milk protein concentrate diluent, η is the viscosity of the milk protein concentrate diluent, and ηₛ is the viscosity of the ion exchanged water.

Subsequently, the specific viscosity and protein concentration of the milk protein concentrate diluent were substituted into the following equation (2) to obtain the reduced viscosity of each milk protein concentrate diluent.

N_{red}=nₛₚ/c (2)

In the above equation (2), η_{red} is the reduced viscosity of the milk protein concentrate diluent, ηₛₚ is the specific viscosity of the milk protein concentrate diluent, and c is the solid concentration of the milk protein concentrate diluent.

Finally, for each milk protein concentrate, a linear function ((reduced viscosity)=a ×(solid concentration)+b) was derived from a pair of the solid concentration in the milk protein concentrate diluent and the reduced viscosity of the milk protein concentrate diluent by the least squares method, and the reduced viscosity, that is, b, at which the solid concentration becomes 0 (g/dL) was obtained from the linear function, and the b was set as the intrinsic viscosity. That is, the intrinsic viscosity is expressed by the following equation (3).

$$[ Formula 1 ]$$

$$\begin{matrix}[ η ] = {}_{C \to 0} \frac{{η}_{red}}{C} & ( 3 )\end{matrix}$$

The intrinsic viscosity obtained from the specific viscosity is equal to the intrinsic viscosity obtained from the inherent viscosity. In this WORKING EXAMPLE, this was verified, and it was confirmed that the above-mentioned intrinsic viscosity obtained from the specific viscosity was accurate.

In addition, as in the WORKING EXAMPLE 1, the sterilized 61^{st} milk protein concentrate, the sterilized 62^{nd} milk protein concentrate, the sterilized 63^{rd} milk protein concentrate, the sterilized 64^{th} milk protein concentrate, and the sterilized 65^{th} milk protein concentrate were preserved at 2 to 4 °C, and the transition of the viscosity of these milk protein concentrates was measured by a B-type viscometer TVB-10M manufactured by Toki Sangyo Co., Ltd., and the results shown in Tables 13 to 17 were obtained. In order to prevent the milk protein concentrates from spoiling during refrigerated preservation, 2-bromo-2-nitropropane-1,3-diol was added to each milk protein concentrate before refrigerated preservation so that the final concentration of 2-bromo-2-nitropropane-1,3-diol was 0.02 mass %. Where the result for the 61^{st} milk protein concentrate is shown in Table 13, the result for the 62^{nd} milk protein concentrate is shown in Table 14, the result for the 63^{rd} milk protein concentrate is shown in Table 15, the result for the 64^{th} milk protein concentrate is shown in Table 16, and the result for 65^{th} milk protein concentrate is shown in Table 17. The tables also show the measurement conditions for viscosity measurement. The results showed that regardless of the type of acid, the viscosity of the one that the pH was adjusted to less than 6.5 after sterilization was maintained lower during refrigerated preservation than the one that the pH was not adjusted to less than 6.5 after sterilization.

TABLE 13

| | Viscosity Measurement | | | | | | CO₂ Conc. |
|---|---|---|---|---|---|---|---|
| | | Measurement | | Rotational | Measurement | pH | Measurement |
| Preserved Period | Viscosity | Temperature | | Speed | Time | Measurement | CO₂ Conc. |
| (day(s)) | (mPa · s) | (°C) | Spindle # | (rpm) | (Second(s)) | pH | (mg/L) |
| 0 | — | — | — | — | — | 6.71 | — |
| 1 | 5910 | 5.0 | M3 | 12 | 60 | — | — |
| 6 | 9680 | 5.8 | M3 | 12 | 60 | — | — |
| 13 | 17000 | 4.8 | M4 | 12 | 60 | — | — |
| 22 | 19610 | 5.4 | M4 | 12 | 60 | — | — |
| 33 | 23100 | 6.2 | M4 | 12 | 60 | 6.77 | — |

TABLE 14

| | Viscosity Measurement | | | | | | CO₂ Conc. |
|---|---|---|---|---|---|---|---|
| | | Measurement | | Rotational | Measurement | pH | Measurement |
| Preserved Period | Viscosity | Temperature | | Speed | Time | Measurement | CO₂ Conc. |
| (day(s)) | (mPa · s) | (°C) | Spindle # | (rpm) | (Second(s)) | pH | (mg/L) |
| 0 | — | — | — | — | — | 6.4 | — |
| 1 | 853 | 5.7 | M2 | 12 | 60 | — | — |
| 6 | 1223 | 6.5 | M2 | 12 | 60 | — | — |
| 13 | 1850 | 5.7 | M2 | 12 | 60 | — | — |
| 22 | 2420 | 5.9 | M2 | 12 | 60 | — | — |
| 33 | 4020 | 6.1 | M3 | 12 | 60 | 6.43 | — |

TABLE 15

| | Viscosity Measurement | | | | | | CO₂ Conc. |
|---|---|---|---|---|---|---|---|
| | | Measurement | | Rotational | Measurement | pH | Measurement |
| Preserved Period | Viscosity | Temperature | | Speed | Time | Measurement | CO₂ Conc. |
| (day(s)) | (mPa · s) | (°C) | Spindle # | (rpm) | (Second(s)) | pH | (mg/L) |
| 0 | — | — | — | — | — | 5.9 | — |
| 1 | 612 | 5.5 | M2 | 12 | 60 | — | — |
| 6 | 624 | 5.9 | M2 | 12 | 60 | — | — |
| 13 | 771 | 5.6 | M2 | 12 | 60 | — | — |
| 22 | 865 | 5.8 | M2 | 12 | 60 | — | — |
| 33 | 936 | 6.4 | M2 | 12 | 60 | 5.94 | — |

TABLE 16

| | Viscosity Measurement | | | | | | CO₂ Conc. |
|---|---|---|---|---|---|---|---|
| | | Measurement | | Rotational | Measurement | pH | Measurement |
| Preserved Period | Viscosity | Temperature | | Speed | Time | Measurement | CO₂ Conc. |
| (day(s)) | (mPa · s) | (°C) | Spindle # | (rpm) | (Second(s)) | pH | (mg/L) |
| 0 | — | — | — | — | — | 5.58 | — |
| 1 | 395 | 5.5 | M2 | 12 | 60 | — | — |
| 6 | 309 | 5.8 | M2 | 12 | 60 | — | — |
| 13 | 282 | 5.7 | M2 | 12 | 60 | — | — |
| 22 | 252 | 5.7 | M2 | 12 | 60 | — | — |
| 33 | 190.6 | 7.2 | M1 | 12 | 60 | 5.6 | — |

TABLE 17

| | Viscosity Measurement | | | | | | CO₂ Conc. |
|---|---|---|---|---|---|---|---|
| | | Measurement | | Rotational | Measurement | pH | Measurement |
| Preserved Period | Viscosity | Temperature | | Speed | Time | Measurement | CO₂ Conc. |
| (day(s)) | (mPa · s) | (°C) | Spindle # | (rpm) | (Second(s)) | pH | (mg/L) |
| 0 | — | — | — | — | — | 5.21 | — |
| 1 | 325 | 5.4 | M2 | 12 | 60 | — | — |
| 6 | 197.6 | 7.4 | M1 | 12 | 60 | — | — |
| 13 | 179.4 | 5.9 | M1 | 12 | 60 | — | — |
| 22 | 149.7 | 6.3 | M1 | 12 | 60 | — | — |
| 33 | 128.2 | 7.1 | M1 | 12 | 60 | 5.22 | — |

The intrinsic viscosities (dL/g) of the 61^{st} to 65^{th} milk protein concentrates preserved in the refrigerator were determined. The results are shown below.
Sterilized 61^{st} milk protein concentrate: 0.396 dL/g
Sterilized 62^{nd} milk protein concentrate: 0.324 dL/g
Sterilized 63^{rd} milk protein concentrate: 0.313 dL/g
Sterilized 64^{th} milk protein concentrate: 1.425 dL/g
Sterilized 65^{th} milk protein concentrate: 2.491 dL/g

Table 18 shows the results of the measurement of the thermal coagulation time at 130 °C of the 61^{st} to 65^{th} milk protein concentrates preserved in the refrigerator, and the thermal coagulation time at 130 °C of the 62^{nd} to 65^{th} milk protein concentrates adjusted to pH 6.5 with 1N aqueous sodium hydroxide solution.

TABLE 18

| | pH unadjusted | pH 6.5 adjusted |
|---|---|---|
| | (minute(s)) | (minute(s)) |
| 61st Milk Protein Concentrate | 12 | — |
| 62nd Milk Protein Concentrate | 0.3 | 1 |
| 63rd Milk Protein Concentrate | 0.1 | 0.8 |
| 64th Milk Protein Concentrate | 0 | 0.2 |
| 65th Milk Protein Concentrate | 0 | 0.3 |

As is clear from Table 18, the 62^{nd} and 63^{rd} milk protein concentrates adjusted to pH 6.5 have thermal stability greater than 0.5 minutes. Therefore, it was confirmed that they can be used as a component of raw materials for milk products requiring heat sterilization.

From the above results, it was considered that in order to maintain a low viscosity, the milk protein concentrate may be preserved at a pH in a range of more than 4.6 and less than 6.5, but in order to maintain a low viscosity and further secure thermal stability after preservation, it is necessary to adjust the intrinsic viscosity to a range of 0.30 dL/g or more and less than 0.35 dL/g.

### Comparative Example 1

By blowing carbon dioxide into 664 kg of skimmed milk (solids concentration: 9.3 mass %, protein content: 3.3 mass %, calcium concentration: 124 mg %) using a microbubble nozzle manufactured by Sakamoto Giken Co., Ltd., the pH of skimmed milk was lowered from 6.70 to 5.79 to prepare acidified skimmed milk. The acidified skimmed milk was concentrated using an ultrafiltration membrane (molecular weight cut-off: 10,000 Da, membrane area: 6.1 m²) manufactured by KOCH Company. Along the way, ion-exchanged water was added to the acidified skimmed milk being concentrated to perform diafiltration, and the acidified skimmed milk was further concentrated. As the result, 87 kg of liquid milk protein concentrate (MPC) with 21.1 mass % of total solids, 16.7 mass % of protein content, 358 mg % of calcium concentration, and pH 6.29 was obtained. The milk protein concentrate is referred to as a primary milk protein concentrate. The thermal coagulation time of this primary milk protein concentrate at 130 °C was 0.5 min, indicating poor thermal stability.

An aqueous potassium hydroxide was then added to the primary milk protein concentrate described above to yield a liquid milk protein concentrate (MPC) with 20.6 mass % of total solids, 16.4 mass % of protein content, and pH 6.53. Hereinafter, this milk protein concentrate is referred to as a secondary milk protein concentrate. The thermal coagulation time of this secondary milk protein concentrate at 130 °C was more than 12 min, indicating sufficient thermal stability.

Subsequently, the above-described secondary milk protein concentrate was subjected to heat sterilization treatment at 130 °C for 4 seconds to obtain a sterilized milk protein concentrate having 20.5 mass % of total solids, 16.5 mass % of protein content, 351 mg % of calcium concentration, and pH 6.53. The sterilized milk protein concentrate was preserved at 2 to 4 °C, and the transition of the viscosity of the milk protein concentrate was measured by a B-type viscometer TVB-10M manufactured by Toki Sangyo Co., Ltd., and the results shown in Table 19 were obtained. As is clear from Table 19, the viscosity of the milk protein concentrate was greater than 30,000 MPa·s at 4 days after the start of refrigerated preservation at 2-4 °C, and the low viscosity could not be maintained.

TABLE 19

| | | Measure- | | | |
|---|---|---|---|---|---|
| Preserved | Viscos- | ment | | Rotational | Measure- |
| Period | ity | Temperature | Spindle | Speed | ment Time |
| (day(s)) | (mPa · s) | (°C) | # | (rpm) | (Second(s)) |
| 0 | 869 | 11.6 | M2 | 12 | 60 |
| 3 | 16990 | 5.0 | M4 | 12 | 60 |
| 4 | 30890 | 4.3 | M4 | 12 | 60 |

1. A method of preserving a liquid milk concentrate in a refrigerated state in which the pH of a heat-sterilized liquid milk concentrate is adjusted to fall within a range of more than 4.6 and less than 6.5.

2. The method according to claim 1, wherein the pH is adjusted so that the intrinsic viscosity of the heat-sterilized liquid milk concentrate at 5 °C is within a range of 0.01 dL/g or more and 0.8 dL/g or less, and the pH of the heat-sterilized liquid milk concentrate is within a range of more than 4.6 and less than 6.5.

3. A method for producing a liquid milk concentrate, comprising:
an acidification step for acidifying the liquid dairy ingredient to prepare a liquid acidified dairy ingredient;
a concentration step for subjecting the acidified dairy ingredient to ultrafiltration to prepare a liquid milk concentrate;
a heat sterilization step for heating and sterilizing the liquid milk concentrate to prepare a sterilized liquid milk concentrate; and
a pH adjustment step for adjusting the pH of the sterilized liquid milk concentrate to be in a range of more than 4.6 and less than 6.5.

4. The method for producing a liquid milk concentrate according to claim 3,
wherein in the acidification step, the liquid dairy ingredient is acidified so that the pH of the liquid milk concentrate obtained in the concentration step is in the range of 6.4 or more and 7.0 or less.

5. The method for producing a liquid milk concentrate according to claim 3,
wherein the dairy ingredient is skimmed milk and
the milk concentrate is a milk protein concentrate.

6. The method for producing a liquid milk concentrate according to claim 3,
wherein in the pH adjustment step, the pH is adjusted so that the intrinsic viscosity of the sterilized liquid milk concentrate at 5 °C is within a range of 0.01 dL/g or more and 0.8 dL/g or less, and the pH of the sterilized liquid milk concentrate is within a range of more than 4.6 and less than 6.5.

7. A liquid milk concentrate produced by the method for producing a liquid milk concentrate according to claim 3.

8. A heat-sterilized milk concentrate having an intrinsic viscosity at 5 °C of range of 0.01 dL/g or more and 0.8 dL/g or less, and a pH of more than 4.6 and less than 6.5.

9. A liquid milk concentrate produced by the method for producing a liquid milk concentrate according to claim 4.

10. A liquid milk concentrate produced by the method for producing a liquid milk concentrate according to claim 5.

11. A liquid milk concentrate produced by the method for producing a liquid milk concentrate according to claim 6.

12. A liquid milk concentrate produced by the method for producing a liquid milk concentrate according to claim 7.
